(19) United States
(12) Patent Application Publication
(10) Pub. No.: US 2026/0037599 A1
(43) Pub. Date: Feb. 5, 2026

(54) WEIGHT-STATIONARY MATRIX MULTIPLY ACCELERATOR WITH TIGHTLY COUPLED L2 CACHE

(71) Applicant: Akeana, Inc., Santa Clara, CA (US)

(72) Inventors: David Cureton Baker, Austin, TX (US); David St Clair Scott, Portland, OR (US); Yogesh Shamkant Thombre, Pleasanton, CA (US)

(73) Assignee: Akeana, Inc., Santa Clara, CA (US)

(21) Appl. No.: 19/289,177

(22) Filed: Aug. 4, 2025

Related U.S. Application Data
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/844,802, filed on Jul. 16, 2025.

(51) Int. Cl. G06F 17/16

(52) U.S. Cl. CPC G06F 17/16

(57) ABSTRACT

An accelerator is accessed. The accelerator includes a weight-stationary systolic array of one or more multiply-accumulate units. The accelerator is coupled to a memory hierarchy and a processor core. The processor core sends a work request to the accelerator. The work request is based on execution of a machine learning model and an activation matrix. In response to the work request, the accelerator loads a weight matrix and the activation matrix. The loading uses the memory hierarchy. The accelerator multiplies the weight matrix by the activation matrix. The multiplication results in an answer matrix. The accelerator stores the answer matrix in the memory hierarchy. The processor core obtains the answer matrix that was stored. The machine learning model is trained. The training produces the weight matrix, which is transposed and saved to the memory hierarchy.

### RELATED APPLICATIONS

This application claims the benefit of U.S. provisional patent applications “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, and “AI Compute Clusters With Noncoherent Shared SRAM” Ser. No. 63/854,877, filed Jul. 31, 2025.

Each of the foregoing applications is hereby incorporated by reference in its entirety.

### FIELD OF ART

This application relates generally to machine learning and more particularly to a weight-stationary matrix multiply accelerator with tightly coupled L2 cache.

### BACKGROUND

Computers and digital networks have revolutionized the ways in which modern people work, play, and interact with one another. Words that were previously committed to paper are now typed or spoken into chats, emails, and digital documents. Images that were drawn on paper, canvas, or plaster walls can now be designed and modified on computer screens. Communications that once took days or weeks to deliver can now be completed in fractions of a second. Nearly any form of document, digital art, scientific discovery, video, or verbal speech can be instantly shared, commented on, or used in collaboration with others across the room or the globe. The recent pandemic has only accelerated our desire and ability to contact and interact with others through digital networks and processing platforms with multi-faceted applications. Three-dimensional digital worlds can be accessed from gaming platforms, home computers, and high-end cell phones. Soon, digital shopping malls, offices, and design studios will be available to customers, complete with digital sales staff and purchasing platforms.

Popular processor architecture categories include Complex Instruction Set Computer (CISC) types and Reduced Instruction Set Computer (RISC) types. A CISC processor instruction may execute various operations. The operations can include loading from and storing to memory, arithmetic operations, logical operations, and so on. In a RISC processor, the instruction sets are smaller than the CISC instruction sets and may execute several operations in a pipelined manner. Pipeline stages can include fetch, decode, and execute. Each of these pipeline stages may take one clock cycle, and thus, the pipelined operation can allow RISC processors to operate on more than one instruction per clock cycle. However, no matter what the architecture, there is never ending pressure on processor vendors to make their products faster, more powerful, and more efficient. And, with the explosion of large language model (LLM) artificial intelligence (AI) applications, the pressure is even greater. The problem is, however, that it is very difficult to design, test, manufacture, and ship processors that are faster and more efficient than their predecessors.

All of this digital computing and networking requires vast amounts of computing power, storage capacity, and energy consumption. As our hunger for entry into expanding global markets and for interactions with fellow humans around the world grows, the requirements for digital access points, network capacities, security, processing platforms, and data storage must grow as well. It is also a national imperative for countries not to be left behind in the so-called digital revolution. We must continue to expand our digital networking and computing capacities, or risk being left behind.

### SUMMARY

New uses continue to be found for processors and systems. Today, processors can be used to accelerate many different types of workloads. These can include simple tasks such as word processing and complex tasks such as modeling three dimensional objects, animating a movie, simulating virtual reality simulation, completing genomic sequencing, and so on. Recent advances in artificial intelligence have shown that new advances are possible in a wide array of applications such as large language models (e.g., chatbots), self-driving cars, cybersecurity, etc. Many of these applications rely on a significant number of processors, often found in a data center, in order to run extremely large machine learning models. Unfortunately, these data centers can consume a tremendous amount of electricity. Thus, there is a need for more efficient processing of machine learning models, while at the same time increasing performance to handle more and more complex workloads.

An accelerator is accessed. The accelerator includes a weight-stationary systolic array of one or more multiply-accumulate units. The accelerator is coupled to a memory hierarchy and a processor core. The processor core sends a work request to the accelerator. The work request is based on execution of a machine learning model and an activation matrix. In response to the work request, the accelerator loads a weight matrix and the activation matrix. The loading uses the memory hierarchy. The accelerator multiplies the weight matrix by the activation matrix. The multiplication results in an answer matrix. The accelerator stores the answer matrix in the memory hierarchy. The processor core obtains the answer matrix that was stored. The machine learning model is trained. The training produces the weight matrix, which is transposed and saved to the memory hierarchy.

A processor-implemented method for tensor processing is disclosed comprising: accessing an accelerator, wherein the accelerator includes a weight-stationary systolic array of one or more multiply-accumulate units, wherein the accelerator is tightly coupled to a memory hierarchy, and wherein the memory hierarchy is coupled to a processor core; sending, by the processor core, a work request to the accelerator, wherein the work request is based on execution of a machine learning model and an activation matrix; loading, by the accelerator, a weight matrix and the activation matrix, wherein the loading is responsive to the work request and wherein the loading uses the memory hierarchy; multiplying, by the accelerator, the weight matrix by the activation matrix, wherein the multiplying results in an answer matrix; storing, by the accelerator, the answer matrix in the memory hierarchy; and obtaining, by the processor core, from the memory hierarchy, the answer matrix that was stored. In embodiments, the sending includes a second work request. In embodiments, the loading includes a second activation matrix. In embodiments, the multiplying includes further multiplying the weight matrix and the second activation matrix. In embodiments, the further multiplying results in a second answer matrix. In embodiments, the storing includes the second answer matrix. In embodiments, the obtaining includes the second answer matrix.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a weight-stationary matrix multiply accelerator with a tightly coupled L2 cache.

FIG. 2 is a flow diagram for weight matrix manipulation.

FIG. 3 is an infographic for a systolic array matrix-multiply accelerator with row tail accumulation.

FIG. 4 is a block diagram of a systolic array matrix-multiply accelerator with row tail accumulation.

FIG. 5 is an example of a systolic array.

FIG. 6 is an infographic of staggered execution.

FIG. 7 is a system diagram for a weight-stationary matrix multiply accelerator with a tightly coupled L2 cache.

### DETAILED DESCRIPTION

Techniques for accelerating matrix multiplication in an accelerator are disclosed. Traditional processors are unable to sustain data bandwidth required to run large machine learning models efficiently. In addition, these processors can often fall short of the ability to process the number of matrix multiplications that are required for a machine learning model to quickly perform an inference. While architectures such as X86, RISC-V, ARM, and so on have added extensions to help accelerate matrix-based calculations, they still fall far short of what is required to run larger machine learning models, such as neural networks with a significant number of neurons. An alternative method of accelerating matrix multiplication that solves these issues is disclosed. A separate IP block is designed to provide an array of matrix multiplications which is tightly coupled to a shared L2 cache with a processor core. The array provides for high computations per second to run large machine models while the shared L2 takes advantage of locality of data within the model. The net result is a matrix multiplication accelerator suitable for efficiently processing today's machine learning workloads.

An accelerator is accessed. The accelerator includes a weight-stationary systolic array of one or more multiply-accumulate units. The accelerator is coupled to a memory hierarchy. The memory hierarchy is also coupled to a processor core. A work request is sent by the processor core to the accelerator. The work request is based on execution of a machine learning model and an activation matrix. The work request can specify the activation matrix. The work request can also specify the weight matrix. In response to the work request, the accelerator optionally loads a weight matrix and then the activation matrix using the memory hierarchy. The accelerator multiplies the weight matrix by the activation matrix, resulting in an answer matrix. The accelerator stores the answer matrix in the memory hierarchy. The accelerator can signal to the processor core when the storing is complete. The processor core obtains the answer matrix that was stored from the memory hierarchy.

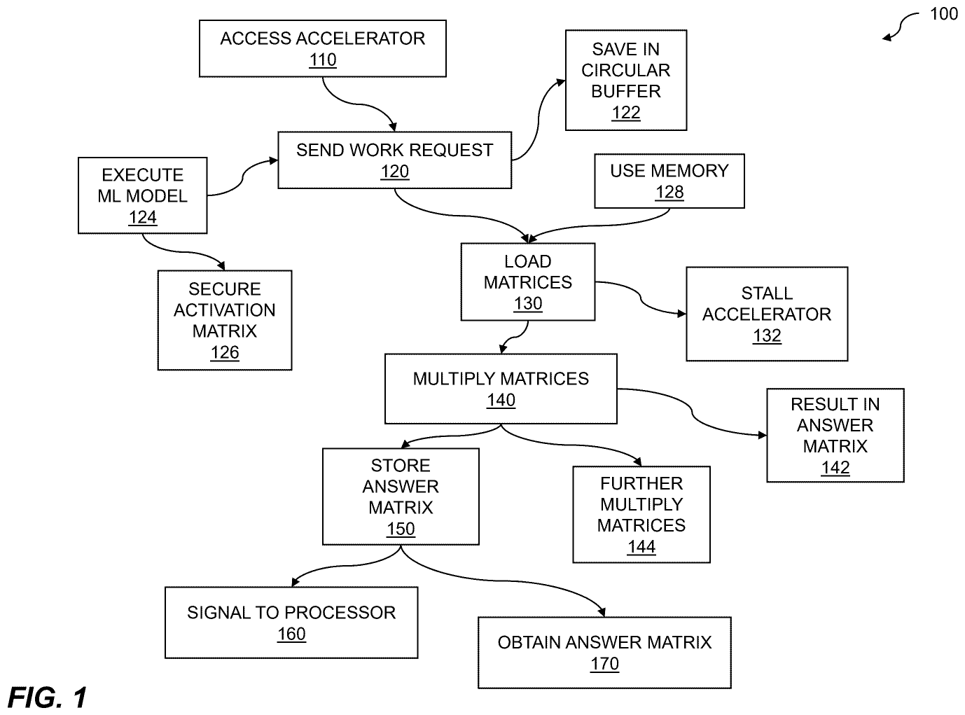

FIG. 1 is a flow diagram for a weight-stationary matrix multiply accelerator with a tightly coupled L2 cache. The flow 100 includes accessing an accelerator 110. The accelerator can be included on a processor, an application-specific integrated circuit (ASIC), a multi-processor, a system-on-chip (SoC), and so on. The accelerator can execute instructions that are part of an instruction set architecture (ISA) such as X86 or ARM, or a custom set of instructions. In embodiments, the accelerator includes a weight-stationary systolic array of one or more multiply-accumulate units. The multiply-accumulate units can include a multiplier circuit, an adder circuit, an accumulator circuit, control circuitry, etc. The systolic array can comprise two or more interconnected multiply-accumulate units to perform parts of a larger multiplication function. In embodiments, the accelerator core is coupled to a memory hierarchy. The memory hierarchy can include one or more cache levels such as a level 1 cache, a level 2 cache, and so on. One or more of the levels of cache can be coherent. In embodiments, the memory hierarchy is coupled to a processor core. The processor core can be included, along with the accelerator, in the processor, ASIC, multi-processor, SoC, and so on. The processor core and the accelerator can comprise different logical blocks or the same logical block. The processor core can execute instructions that are part of an instruction set architecture (ISA) such as X86, ARM, and so on. The processor core can implement custom instructions which can be used to communicate with the accelerator.

The flow 100 includes sending, by the processor core, a work request 120 to the accelerator core. The work request can include a location, within the memory hierarchy, of a weight array, an activation array, and so on. The work request can specify where in the memory hierarchy an answer matrix should be stored by the accelerator. In embodiments, the sending can include a second work request. Any number of work requests can be sent to the accelerator. In embodiments, the work request is saved in a circular buffer 122 within the accelerator. Alternatively, the accelerator can include any other buffer, FIFO, and so on to collect work requests. If the processor core sends a new work request when the circular queue is full, the processor can stall the new work request until the accelerator finishes an existing work request and space is reallocated in the circular buffer. In embodiments, the work request is based on execution of a machine learning model 124 and an activation matrix. The processor can execute a machine learning model, such as a neural network, convolutional neural network, and so on. In embodiments, the execution of the machine learning model includes securing the activation matrix 126, by the processor core, in the memory hierarchy. In further embodiments, the work request specifies the activation matrix. The activation matrix can be specified, in the work request, by an address in the memory hierarchy. The work request can also specify the weight matrix. The work request can include a size of the activation matrix, data types of elements in the matrix, an addressing mode, and other information. The work request can specify the size of the weight matrix, data types, addressing mode, and other information associated with the weight matrix. In both cases, the address can be a physical address.

The flow 100 includes loading, by the accelerator, a weight matrix and the activation matrix 130. The weight matrix can be generated during training of the machine learning model that runs on the processor. The weight matrix can be kept in storage, RAM, SDRAM, a hard disk, etc. until needed by the accelerator. The activation matrix can be generated and stored in the hierarchical memory by the processor. In embodiments, the loading is responsive to the work request. The accelerator can obtain the needed information to load the weight matrix and the activation matrix from the hierarchical memory form work request. Thus, in embodiments, the loading uses the memory hierarchy 128. As mentioned previously, the accelerator can be coupled to a cache such as an L2 cache. The L2 cache can be tightly coupled to the accelerator and to the processor core. A cache miss can occur when the accelerator attempts to load either matrix from memory. Embodiments include stalling, by the accelerator 132, wherein the loading results in a cache miss.

The flow 100 includes multiplying, by the accelerator, the weight matrix by the activation matrix 140. The multiplying can comprise a matrix multiply function. The multiplying can be accomplished by the weight-stationary systolic array within the accelerator. The array can include a plurality of multiply-accumulate circuits. Each circuit can operate on a data type that is accepted as an input. These data types can include BF16, FP16, or another data type. The multiply-accumulate circuits can be arranged in rows and columns to form the array. The weight matrix can be first loaded into the array, followed by the activation matrix. The two arrays can then be multiplied. In embodiments, the multiplying results in an answer matrix 142. The answer matrix can be saved in the accelerator until it is written back to memory. In embodiments, the loading includes a second activation matrix. Once the first multiplication is complete, the weight matrix can remain within the multiply-accumulate circuits while a new activation matrix is loaded for the next multiplication. In this way, the weights can remain “stationary” in the array while new activations are loaded into the array. In embodiments, the multiplying includes further multiplying the weight matrix and the second activation matrix 144. In further embodiments, the further multiplying results in a second answer matrix.

The flow 100 includes storing, by the accelerator, the answer matrix 150 in the memory hierarchy. The storing can occur at the address in memory that was specified by the work request. The memory hierarchy can include an L2 cache which can be tightly coupled to the processor core, enabling fast data sharing between the processor core and the accelerator. The storing can occur after the multiplying. As explained above, more than one multiplication can occur in the array before the answer matrix is stored. In embodiments, the storing includes the second answer matrix. Any number of answer matrices can be saved in the accelerator before being stored to the memory hierarchy. Embodiments include signaling to the processor core 160, by the accelerator, when the storing is complete. When a work request is complete and one or more answer matrices have been stored to the memory hierarchy, the accelerator can indicate to the processor core that it is safe to load the answer matrix from the memory hierarchy. The loading can occur from the memory location that was specified in the work request. The flow 100 includes obtaining, by the processor core, from the memory hierarchy, the answer matrix 170 that was stored. The answer matrix can be loaded, by the processor core, at the memory location that was in the work request. In embodiments, the obtaining includes the second answer matrix. In this way, one or more weight matrices, one or more activation matrices, and one or more answer matrices can be iteratively and rapidly shared between the processor core and accelerator, enabling fast data access. This can significantly enhance performance when a machine learning model is running inferences on the processor core. Further exchanges of data between the array and processor core based on additional work requests are possible as the machine learning model continues to perform inferences.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

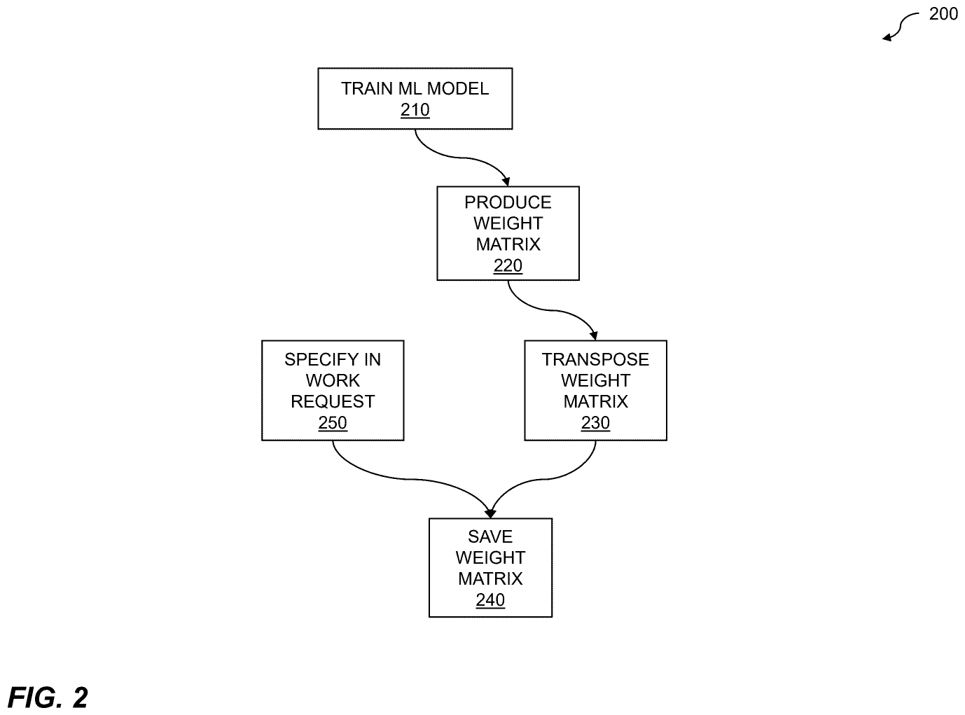

FIG. 2 is a flow diagram for weight matrix manipulation. Weight matrix manipulation can enable a weight-stationary matrix multiply accelerator with a tightly coupled L2 cache. The flow 200 includes training a machine learning (ML) model 210. The ML model can comprise various layers, topologies, connectivities, and so on. The training can be accomplished using a variety of training techniques, such as supervised learning, unsupervised learning, semi-supervised learning, reinforcement learning, etc. The machine learning model can comprise a neural network, convolutional neural network, or any other kind of machine learning model. The machine learning model can be trained to determine the proper weights between neurons so that the model produces an accurate inference.

In the flow 200, the training the ML model produces a weight matrix 220. The weight matrix can include the weights for one or more neurons within the model to be multiplied against a set of activations. The flow 200 includes transposing the weight matrix 230. The weight matrix can be transposed for efficiency when being loaded into the array of the accelerator. The flow 200 includes saving the weight matrix 240. The weight matrix can be saved in an L2 cache of the accelerator. Saving the weight matrix to an L2 cache can be very efficient, however, it can also be saved to other levels of the memory hierarchy and brought into the L2 cache when needed. In the flow 200, the transposed, saved weight matrix can be specified in a work request 250. The work request can marshal various accelerator resources to perform tasks necessitated by currently running code. Some embodiments comprise training the machine learning model. In embodiments, the training produces the weight matrix. Some embodiments comprise transposing the weight matrix. Some embodiments comprise saving the weight matrix that was transposed to the memory hierarchy. In embodiments, the work request specifies the weight matrix that was saved.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

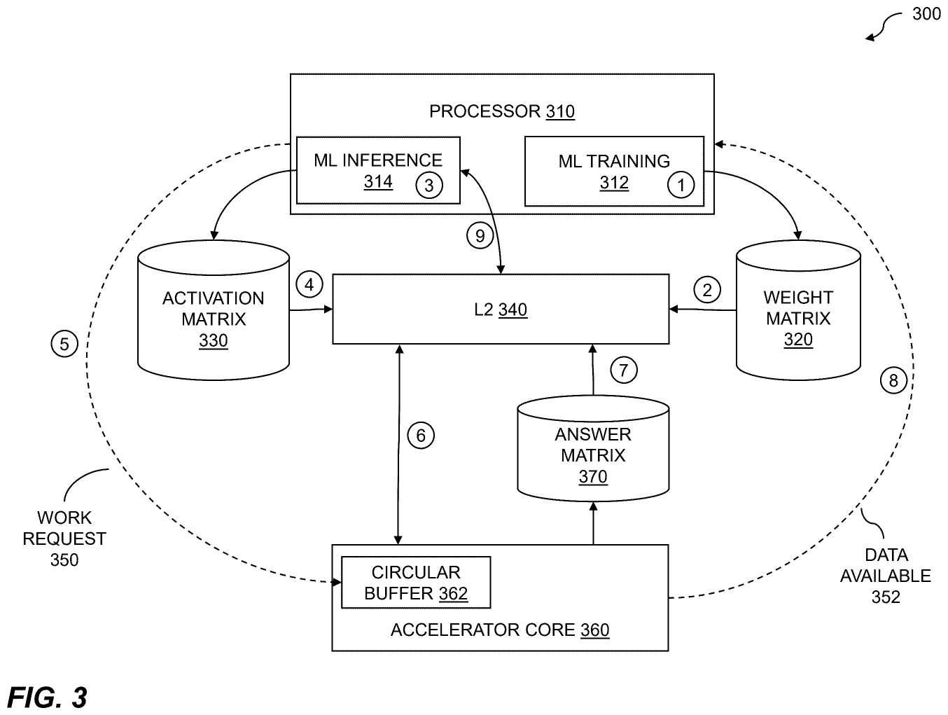

FIG. 3 is an infographic for a systolic array matrix-multiply accelerator with row tail accumulation. A systolic array matrix-multiply accelerator can comprise a weight-stationary matrix multiply accelerator with a tightly coupled L2 cache. An accelerator is accessed. The accelerator includes a weight-stationary systolic array of one or more multiply-accumulate units. The accelerator is coupled to a memory hierarchy. The memory hierarchy is also coupled to a processor core. A work request is sent by the processor core to the accelerator. The work request is based on execution of a machine learning model and an activation matrix. The work request can specify the activation matrix. The work request can also specify the weight matrix. In response to the work request, the accelerator optionally loads a weight matrix and then the activation matrix using the memory hierarchy. The accelerator multiplies the weight matrix by the activation matrix, resulting in an answer matrix. The accelerator stores the answer matrix in the memory hierarchy. The accelerator can signal to the processor core when the storing is complete. The processor core obtains the answer matrix that was stored from the memory hierarchy.

The infographic 300 includes a processor 310. The processor 310 can include a RISC-V processor, MIPS processor, ARM processor, x86 processor, or other suitable processor type. The processor 310 can include a module for machine learning training 312. The module for machine learning training can include functions and instructions for training a machine learning model. The training can include deriving a weight matrix 320. One or more exemplary implementations may utilize Random Initialization with Gradient Descent. At the start of training, weights in the matrix can be initialized randomly, with values selected from a small range to prevent the network from being biased in one direction. The training process then can use a gradient descent algorithm (or one of its variants) to adjust these weights based on the model error, iteratively minimizing the loss function. In exemplary implementations, the adjustment is accomplished through backpropagation, where gradients of the error with respect to each weight are calculated, and the weights are updated accordingly in the weight matrix. The weight matrix is then loaded into an L2 cache 340. Once the training is complete, the model can be used for inferencing. The processor 310 can include a module for machine learning inference 314. The module for machine learning inference can include functions and instructions for inferencing using a previously trained machine learning model. The inferencing can include deriving an activation matrix 330. In exemplary implementations, during the inferencing process, the activation matrix can be computed by feeding input data through a neural network, layer by layer, using the learned weights and biases. Each layer applies its specific activation function, such as ReLU (rectified linear unit), Sigmoid, or the like, on the linear combination of inputs and weights. The resulting values form the activation matrix for each layer, which can then become the input for the next layer. The activation matrix 330 is also loaded into the L2 cache 340.

With the weight matrix 320 and activation matrix 330 loaded into the L2 cache 340, the accelerator core 360 can receive a work request 350 from the processor 310. In exemplary implementations, the processor 310 issues work requests once the weight matrix 320 and activation matrix 330 are successfully loaded into the L2 cache 340. The work request can include an instruction to perform a matrix operation, such as a matrix multiplication, multiply-accumulate operation, normalization, and/or other operations. The work request can be based on a semaphore. In exemplary implementations, a circular buffer 362 within the accelerator core 360 receives the work request. In exemplary implementations, the circular buffer includes multiple entries, and therefore has the capability to store multiple work requests. Thus, in exemplary implementations, the work requests can be queued.

The accelerator core 360 retrieves work requests from the circular buffer. The work request can specify a source address within the L2 cache that corresponds to the weight matrix. Additionally, the work request can specify a source address within the L2 cache that corresponds to the activation matrix. The work request can include an instruction to perform multiplication, multiply-accumulate operations, normalization, and/or other matrix operations. The results are put into answer matrix 370. The work request can specify a destination address within the L2 cache at which the accelerator can store the answer matrix. Once the answer matrix is stored in the L2 cache, the accelerator core can assert a data available signal 352, to indicate to the processor that the answer matrix is available for retrieving from the L2 cache. The data available signal can be based on a semaphore. A cache miss can occur, which can cause the accelerator core to pause until the activation matrix and weight matrix are loaded.

In exemplary implementations the work request can include an opcode field. The opcode field can be used by the accelerator core to determine the operation type. Operation types can include matrix operations, such as multiplication, addition, subtraction, division, and other operations that can occur on matrices. The opcode field can include a flush operation. The flush operation, when received by the accelerator core, can cause the accelerator core to discard all pending work requests in the circular buffer 362. The flush operation can enable improved resource management. When a queue has accumulated several pending requests that are no longer needed, perhaps due to updated data or an interrupted operation, the flush operation of disclosed implementations allows the accelerator core to discard these requests, freeing up space and resources. In exemplary implementations, the work request can include stride parameters. The stride parameters can be used to program one or more registers to use an indexed stride that is compatible with the size of a given weight matrix, activation matrix, and/or answer matrix. Setting a compatible stride can increase efficiency when fetching matrix data from the L2 cache 340.

As the machine learning model continues to execute, another activation matrix can be sent to the L2 cache and the process can restart. When restarting, the weight matrix can be saved within the accelerator core so that only the new activation matrix needs to be loaded to perform another matrix multiplication. In this way, the weights can be “stationary” in the accelerator. The weight stationary approach provides an advantage of allocating more bandwidth to activation matrix data once the weight matrix has been loaded.

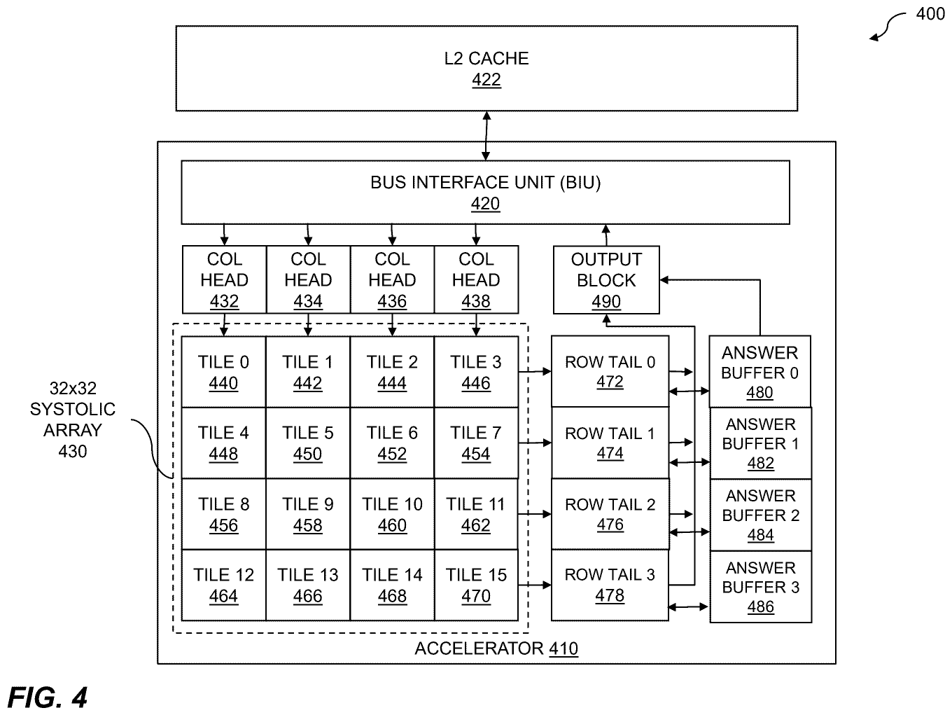

FIG. 4 is a block diagram of a systolic array matrix-multiply accelerator with row tail accumulation. A systolic array matrix-multiply accelerator with row tail accumulation can comprise a weight-stationary matrix multiply accelerator with a tightly coupled L2 cache. An accelerator is accessed. The accelerator includes a weight-stationary systolic array of one or more multiply-accumulate units. The accelerator is coupled to a memory hierarchy. The memory hierarchy is also coupled to a processor core. A work request is sent by the processor core to the accelerator. The work request is based on execution of a machine learning model and an activation matrix. The work request can specify the activation matrix. The work request can also specify the weight matrix. In response to the work request, the accelerator optionally loads a weight matrix and then the activation matrix using the memory hierarchy. The accelerator multiplies the weight matrix by the activation matrix, resulting in an answer matrix. The accelerator stores the answer matrix in the memory hierarchy. The accelerator can signal to the processor core when the storing is complete. The processor core obtains the answer matrix that was stored from the memory hierarchy.

The block diagram 400 shows a 32×32 systolic array 430 which can be coupled to a memory hierarchy. The memory hierarchy can include an L2 cache 422. The L2 cache 422 can be tightly coupled to a processor core to enable fast data sharing between the accelerator 410 and a processor core. The L2 cache can be coherent. The memory hierarchy can include any number of caches, main memory, disk storage, and so on. The accelerator can include a bus interface unit (BIU) 420. The BIU can provide control for communications between the accelerator and the L2 cache. These communications can include loading a weight matrix, loading an activation matrix, storing an answer matrix, and so on. The accelerator can include one or more column headers. The column headers are shown at 432, 434, 436, and 438 on block diagram 400. The column headers can load data from one or more matrices from the BIU into an array within the accelerator. The column headers can unpack data from the BIU into an internal input format. In exemplary implementations, the internal input format can include a quintuple format. The column heads can shift data into the array in a staggered manner. The shifting can be based on one or more registers to ensure that timing requirements are met due to long RC delays down columns of the array. The array can comprise a grid of 16 tiles as shown in block diagram 400. Each tile can include eight multiply-add units. Thus, the entire array can comprise a 32×32 systolic array 430. Each multiply-add unit can comprise a vector dot product engine that can perform a dot product operation on BF16 data types, MXFP8, MXFP6, MXFP4, INT8, and/or other suitable data types. In exemplary implementations, each of the eight vector dot product engines within each of the 16 tiles can be called a VDP16. Results from each multiply-add (or VDP16) can be summed and added across the array. The final partial product results can be saved in a row tail. Thus, as shown in block diagram 400, a first row in the multiply-add array can create partial products corresponding to a first portion of the 32 dot products via tiles 440, 442, 444, and 446. The results of the first row of tiles can be summed and saved in the row tail 472. A second row in the multiply-add array can create partial products corresponding a second portion of the 32 dot products via tiles 448, 450, 452, and 454. The results of the second row of tiles can be summed and saved in the row tail 474. A third row in the multiply-add array can create partial products corresponding a third portion of the 32 dot products via tiles 456, 458, 460, and 462. The results of the third row of tiles can be summed and saved in the row tail 476. A fourth row in the multiply-add array can create partial products corresponding to a fourth portion of the 32 dot products via tiles 464, 466, 468, and 470. The results of the fourth row of tiles can be summed and saved in the row tail 478. Using the structure shown in block diagram 400, the accelerator can load a 32×32 weight matrix into the array, load a 32×32 activation matrix into the array, and perform the matrix multiplication by using the multiply-add arranged in disclosed rows and columns.

The systolic array can be pipelined. Each cycle of the systolic array can start an additional multiplication of an additional activation matrix by the loaded weight matrix. For example, on a first cycle, column header 432 can send an activation to tile 0 which can determine a first partial product according to a first multiplication. Results can be forwarded by tile 0 to tile 1, where it can be saved for use in the next cycle. During a second cycle, multiple actions can occur. Column header 432 can send another activation to tile 0 which can determine a first partial product according to a second multiplication. Also in the second cycle, tile 1 can execute the second partial product of the first multiplication, accumulating results with those that were forwarded by tile 0 in the previous cycle. Finally, in the same cycle, column header 432 can send another activation corresponding to the first multiplication to tile 4. Since each row can work on four partial products, the column header can send tile 4 an activation associated with a fifth partial product. In this way, multiple multiplications can proceed in a “diagonal wave” across the systolic array. When the array comprises a 4×4 array of tiles, the array can be pipelined to operate on four multiplications at once.

The row tails can send results to a corresponding answer buffer which can save one or more answer matrices from one or more matrix-multiply functions. The BIU can store one or more answer matrices back to the memory hierarchy. In the block diagram 400, row tail 0 472 is matched with corresponding answer buffer 0 480. Row tail 1 474 is matched with corresponding answer buffer 1 482. Row tail 2 476 is matched with corresponding answer buffer 2 484. Row tail 3 478 is matched with corresponding answer buffer 3 486. One or more implementations can include more or fewer rows and columns than depicted in FIG. 4.

The row tails and/or answer buffers can send data to the output block 490. The data may arrive at the output block in a staggered manner. Thus, in embodiments, the sending is staggered between the associated row tail and the second associated row tail, wherein the staggering is based on a clock cycle of the accelerator. The output block 490 can temporally destagger the output by collecting the entire answer matrix in the output block over a number of clock cycles. Thus, embodiments can include destaggering, by the output block, the result of the accumulating and the second result of the accumulating, wherein the destaggering results in a final answer. Once the output block contains a complete answer matrix, the output block provides the answer matrix data to the bus interface unit. The bus interface unit then loads the answer matrix data in the L2 cache.

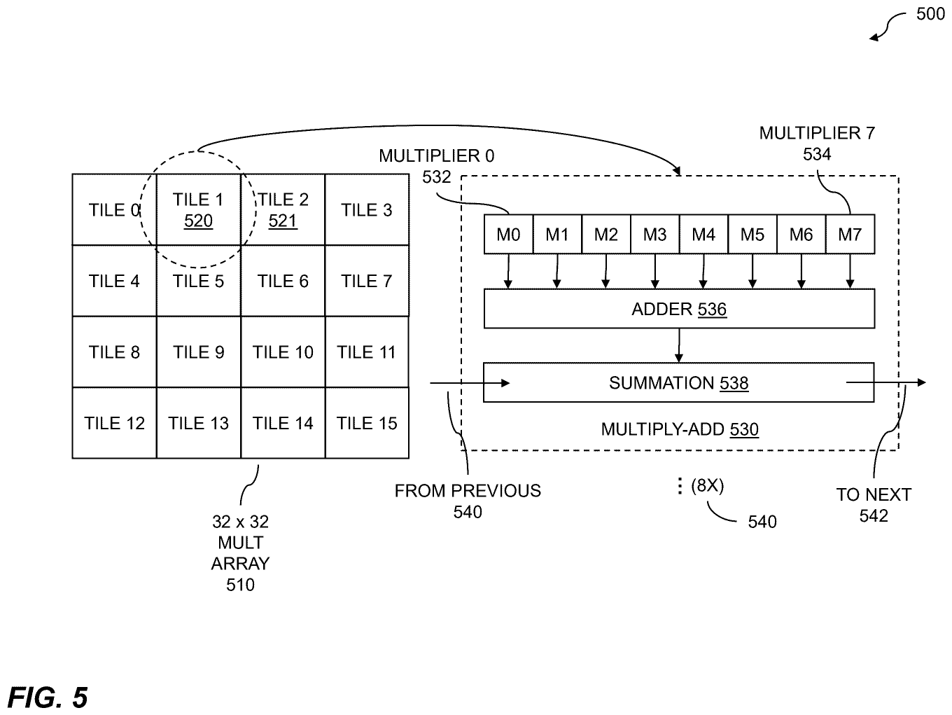

FIG. 5 is an example of a systolic array. A systolic array can enable a weight-stationary matrix multiply accelerator with a tightly coupled L2 cache. An accelerator is accessed. The accelerator includes a weight-stationary systolic array of one or more multiply-accumulate units. The accelerator is coupled to a memory hierarchy. The memory hierarchy is also coupled to a processor core. A work request is sent by the processor core to the accelerator. The work request is based on execution of a machine learning model and an activation matrix. The work request can specify the activation matrix. The work request can also specify the weight matrix. In response to the work request, the accelerator optionally loads a weight matrix and then the activation matrix using the memory hierarchy. The accelerator multiplies the weight matrix by the activation matrix, resulting in an answer matrix. The accelerator stores the answer matrix in the memory hierarchy. The accelerator can signal to the processor core when the storing is complete. The processor core obtains the answer matrix that was stored from the memory hierarchy.

In the example 500, a systolic array 510 is shown. The systolic array can comprise a systolic array of 16 tiles, as shown in the example 500. In embodiments, each tile within the systolic array of tiles includes eight multiply-accumulate units (MACs). Thus, the entire array can comprise a 32×32 multiply array. The example 500 shows the details of a tile such as tile 1 520. A single multiply-add unit 530 of eight total multiply-add units 540 within tile 1, is shown. In embodiments, each row within the plurality of rows comprises a stream of eight partial products which can be part of a matrix-multiply operation. Each multiply-add unit can include eight separate multiplier units. These can be multiplier 0 532 through multiplier 7 534, as shown in the example 500. Multiplier 0 can be aligned on the left of each multiply-add unit and multiplier 7 can be aligned on the right of each multiply-add unit. Other alignments are possible. Each of the multiplier units within the multiply-add can perform eight multiplications on various data formats such as BF16 data, FP16 data, MXFP8 data, MXFP6 data, MXFP4 data, INT8 data, and/or other suitable data types and/or other data formats. The data formats can include an internal quintuple format (previously described) that can be generated by the aforementioned column heads. Once the multiplications are complete within the tile, each set of eight multipliers can be summed by an adder, such as adder 536. The results of the adder can be sent to a summation block 538 within the multiply-add unit. The summation block can take one of eight previous partial product results from a previous multiply-add unit 540, add current results from the adder, and send to the next multiply-add unit 542 for continued summation of partial products across the entire row of multiply-add units across the array. The multiply-add unit 530 can include one or more arithmetic units to perform multiply and/or addition operations. In exemplary implementations, special processing is performed to accommodate scenarios such as handling infinity, and/or Not-a-Number (NaN) conditions. In exemplary implementations, a lookup table is used to determine if a special case result is zero, NaN, or a signed infinity value. The lookup table can include two input arguments that include two input values for an arithmetic operation. As an example, for multiplication, a NaN input value in conjunction with any other value results in a NaN output value. Similarly, for addition, a first input argument of infinity and a second input argument of negative infinity results in a NaN output value. Thus, disclosed implementations can utilize a lookup table to accommodate special conditions and corner cases associated with NaN, infinity, zero, and/or other unusual values.

Aforementioned row tails can store the summed result of all partial products in the row at the end of the array. Each tile can comprise a stack of eight multiply-add units, each summing results across a row of the array, such as described above. For example, the eight multiply-add units within tile 520 can multiply 64 different sets of values, and can use adders to create eight results that are sent along rows as inputs to the summation block in the following tile 521. The same function can be performed by tile 521, passing eight partial product results to the next tile. This process can continue until the final result of the row is stored in the row tail.

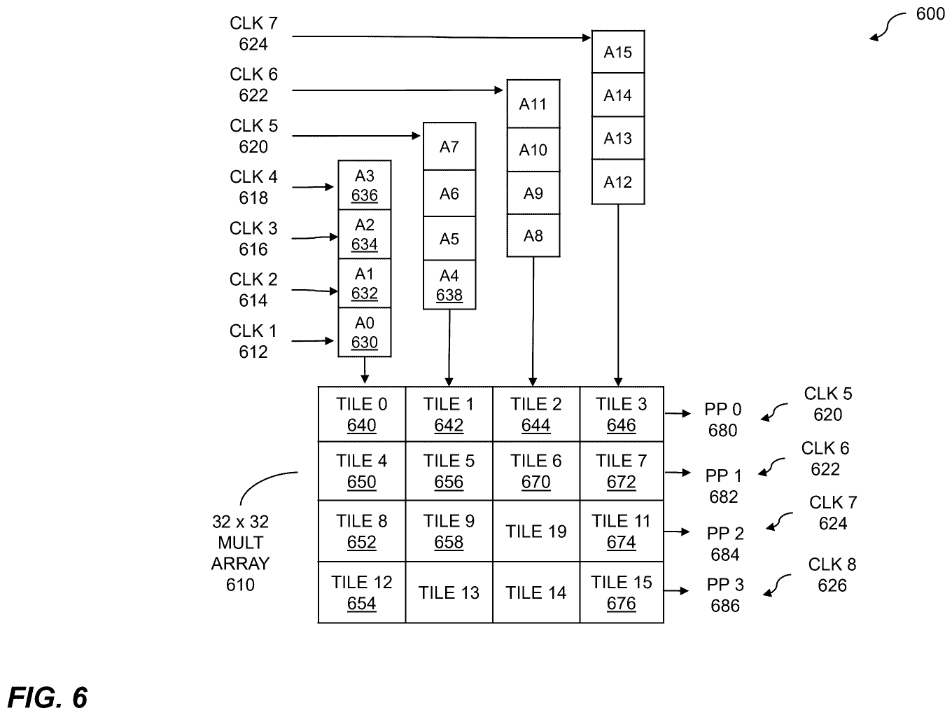

FIG. 6 is an infographic of staggered execution. Staggered execution can enable a weight-stationary matrix multiply accelerator with a tightly coupled L2 cache. An accelerator is accessed. The accelerator includes a weight-stationary systolic array of one or more multiply-accumulate units. The accelerator is coupled to a memory hierarchy. The memory hierarchy is also coupled to a processor core. A work request is sent by the processor core to the accelerator. The work request is based on execution of a machine learning model and an activation matrix. The work request can specify the activation matrix. The work request can also specify the weight matrix. In response to the work request, the accelerator optionally loads a weight matrix and then the activation matrix using the memory hierarchy. The accelerator multiplies the weight matrix by the activation matrix, resulting in an answer matrix. The accelerator stores the answer matrix in the memory hierarchy. The accelerator can signal to the processor core when the storing is complete. The processor core obtains the answer matrix that was stored from the memory hierarchy.

In the infographic 600, seven clock cycles are indicated, shown as CLK 1 612, CLK 2 614, CLK 3 616, CLK 4 618, CLK 5 620, CLK 6 622, and CLK 7 624. With each clock cycle, data is fed from one or more column headers into the first row of tiles of a systolic array, indicated as tile 0 640, tile 1 642, tile 2 644, and tile 3 646. On the first clock cycle (CLK 1 612), activation matrix element A0 630 is loaded into tile 0. On the second clock cycle (CLK 2 614), the activation matrix element A1 632 is loaded into tile 4 650, while matrix element A4 638 is loaded into tile 1 642. In clock cycle 3 616, matrix element A2 634 is loaded into tile 8 652 while matrix element A5 is loaded into tile 5 656, and matrix element A8 is loaded into tile 2 644. In clock cycle 4 618, matrix element A3 636 is loaded into tile 12 654, while matrix element A6 is loaded into tile 9 658, matrix element A9 is loaded into tile 6 670, and matrix element A12 is loaded into tile 3 646. The process continues until all the activation matrix elements A0 through A15 propagate through the array 610. Upon completion of CLK 5 620, a first partial product (PP 0 680) is available at the output of tile 3 646. Similarly, upon completion of CLK 6 622, a second partial product (PP 1 682) is available at the output of tile 7 672, and upon completion of CLK 7 624, a third partial product (PP 2 684) is available at the output of tile 11 674. By clock cycle 8 (CLK 8 626), the final partial product (PP 3 686) is available at the output of tile 15 676. Accordingly, the output that includes the partial products is staggered as it exits the systolic array. In embodiments, a partial product is staggered as it exits the systolic array.

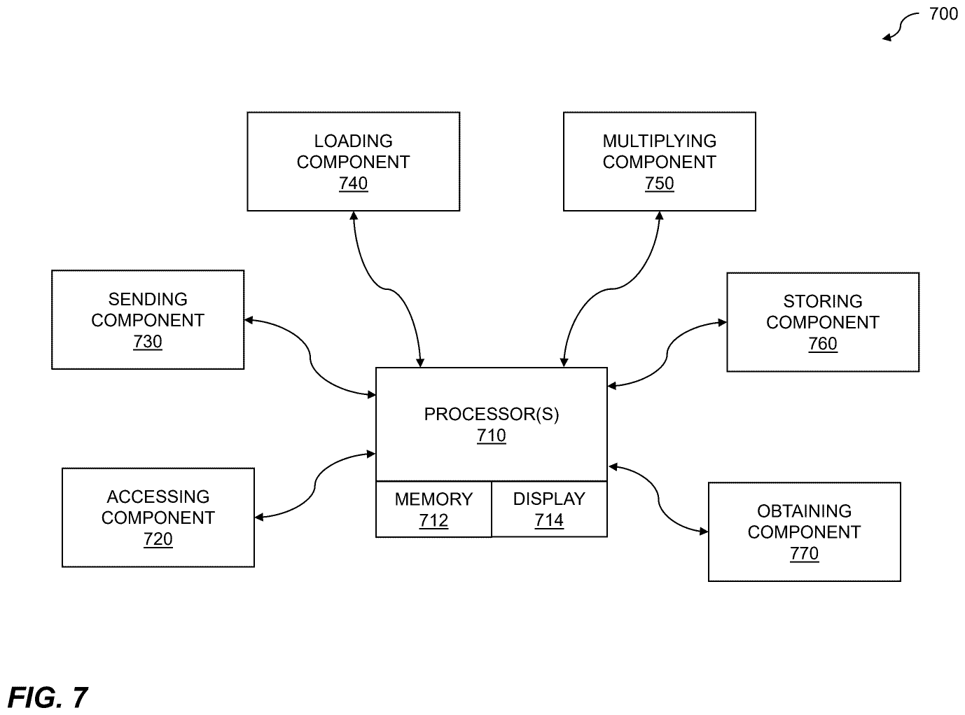

FIG. 7 is a system diagram for a weight-stationary matrix multiply accelerator with a tightly coupled L2 cache. The system can include instructions and/or functions for generation and/or manipulation of design data such as hardware description language (HDL) constructs for specifying structure and operation of an integrated circuit. The system can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system 700 can include one or more processors 710. The one or more processor cores can include RISC-V™ processor cores. The one or more processors 710 are coupled to a memory 712 which stores instructions, operations, system timer counts, one or more weight matrices, one or more activation matrices, one or more answer matrices, and so on. The system 700 can further include a display 714 coupled to the one or more processors 710. The display can be used for displaying data, instructions, operations, memory queue contents, various types of matrices, work requests, and the like. In embodiments, one or more processors 710 are coupled to the memory 712, wherein the one or more processors, when executing the instructions which are stored, are configured to: access an accelerator, wherein the accelerator includes a weight-stationary systolic array of one or more multiply-accumulate units, wherein the accelerator is coupled to a memory hierarchy, and wherein the memory hierarchy is coupled to a processor core; send, by the processor core, a work request to the accelerator, wherein the work request is based on execution of a machine learning model and an activation matrix; load, by the accelerator, a weight matrix and the activation matrix, wherein the loading is responsive to the work request and wherein the loading uses the memory hierarchy; multiply, by the accelerator, the weight matrix by the activation matrix, wherein the multiplying results in an answer matrix; store, by the accelerator, the answer matrix in the memory hierarchy; and obtain, by the processor core, from the memory hierarchy, the answer matrix that was stored.

The system 700 can include an accessing component 720. The accessing component 720 can include functions and instructions for accessing an accelerator, wherein the accelerator includes a weight-stationary systolic array of one or more multiply-accumulate units, wherein the accelerator is coupled to a memory hierarchy, and wherein the memory hierarchy is coupled to a processor core. The multiply-accumulate units can include a multiplier circuit, an adder circuit, an accumulator circuit, control circuitry, etc. The memory hierarchy can include one or more cache levels such as a level 1 cache, a level 2 cache, and so on.

The system 700 can include a sending component 730. The sending component can include functions and instructions for sending, by the processor core, a work request to the accelerator, wherein the work request is based on execution of a machine learning model and an activation matrix. The work request can include a location, within the memory hierarchy, of a weight array, an activation array, and so on. The work request can specify where in the memory hierarchy an answer matrix should be stored by the accelerator.

The system 700 can include a loading component 740. The loading component can include functions and instructions for loading, by the accelerator, a weight matrix and the activation matrix, wherein the loading is responsive to the work request and wherein the loading uses the memory hierarchy. The weight matrix can be generated during training of the machine learning model that runs on the processor. The weight matrix can be kept in storage, RAM, SDRAM, a hard disk, etc. until needed by the accelerator. The activation matrix can be generated and stored in the hierarchical memory by the processor.

The system 700 can include a multiplying component 750. The multiplying component can include functions and instructions for multiplying, by the accelerator, the weight matrix by the activation matrix, wherein the multiplying results in an answer matrix. The multiplying can comprise a matrix multiply function. The multiplying can be accomplished by the weight-stationary systolic array within the accelerator.

The system 700 can include a storing component 760. The storing component can include functions and instructions for storing, by the accelerator, the answer matrix in the memory hierarchy. The storing can occur at the address in memory that was specified by the work request.

The system 700 can include an obtaining component 770. The obtaining component can include functions and instructions for obtaining, by the processor core, from the memory hierarchy, the answer matrix that was stored. The answer matrix can be loaded, by the processor core, at the memory location that was in the work request.

The system 700 can include a computer program product embodied in a non-transitory computer readable medium for instruction execution, the computer program product comprising code which causes one or more processors to generate semiconductor logic for: accessing an accelerator, wherein the accelerator includes a weight-stationary systolic array of one or more multiply-accumulate units, wherein the accelerator is coupled to a memory hierarchy, and wherein the memory hierarchy is coupled to a processor core; sending, by the processor core, a work request to the accelerator, wherein the work request is based on execution of a machine learning model and an activation matrix; loading, by the accelerator, a weight matrix and the activation matrix, wherein the loading is responsive to the work request and wherein the loading uses the memory hierarchy; multiplying, by the accelerator, the weight matrix by the activation matrix, wherein the multiplying results in an answer matrix; storing, by the accelerator, the answer matrix in the memory hierarchy; and obtaining, by the processor core, from the memory hierarchy, the answer matrix that was stored.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for machine learning comprising:
accessing an accelerator, wherein the accelerator includes a weight-stationary systolic array of one or more multiply-accumulate units, wherein the accelerator is coupled to a memory hierarchy, and wherein the memory hierarchy is coupled to a processor core;
sending, by the processor core, a work request to the accelerator, wherein the work request is based on execution of a machine learning model and an activation matrix;
loading, by the accelerator, a weight matrix and the activation matrix, wherein the loading is responsive to the work request and wherein the loading uses the memory hierarchy;
multiplying, by the accelerator, the weight matrix by the activation matrix, wherein the multiplying results in an answer matrix;
storing, by the accelerator, the answer matrix in the memory hierarchy; and
obtaining, by the processor core, from the memory hierarchy, the answer matrix that was stored.

2. The method of claim 1 wherein the sending includes a second work request.

3. The method of claim 2 wherein the loading includes a second activation matrix.

4. The method of claim 3 wherein the multiplying includes further multiplying the weight matrix and the second activation matrix.

5. The method of claim 4 wherein the further multiplying results in a second answer matrix.

6. The method of claim 5 wherein the storing includes the second answer matrix.

7. The method of claim 6 wherein the obtaining includes the second answer matrix.

8. The method of claim 1 further comprising training the machine learning model.

9. The method of claim 8 wherein the training produces the weight matrix.

10. The method of claim 9 further comprising transposing the weight matrix.

11. The method of claim 10 further comprising saving the weight matrix that was transposed to the memory hierarchy.

12. The method of claim 11 wherein the work request specifies the weight matrix that was saved.

13. The method of claim 1 wherein the execution of the machine learning model includes securing the activation matrix, by the processor core, in the memory hierarchy.

14. The method of claim 11 wherein the work request specifies the activation matrix.

15. The method of claim 1 further comprising signaling to the processor core, by the accelerator, when the storing is complete.

16. The method of claim 1 further comprising stalling, by the accelerator, wherein the loading results in a cache miss.

17. The method of claim 1 wherein the work request is saved in a circular buffer within the accelerator.

18. The method of claim 1 wherein a partial product is staggered as it exits the systolic array.

19. A computer program product embodied in a non-transitory computer readable medium for instruction execution, the computer program product comprising code which causes one or more processors to generate semiconductor logic for:
accessing an accelerator, wherein the accelerator includes a weight-stationary systolic array of one or more multiply-accumulate units, wherein the accelerator is coupled to a memory hierarchy, and wherein the memory hierarchy is coupled to a processor core;
sending, by the processor core, a work request to the accelerator, wherein the work request is based on execution of a machine learning model and an activation matrix;
loading, by the accelerator, a weight matrix and the activation matrix, wherein the loading is responsive to the work request and wherein the loading uses the memory hierarchy;
multiplying, by the accelerator, the weight matrix by the activation matrix, wherein the multiplying results in an answer matrix;
storing, by the accelerator, the answer matrix in the memory hierarchy; and
obtaining, by the processor core, from the memory hierarchy, the answer matrix that was stored.

20. A computer system for instruction execution comprising:
a memory which stores instructions;
one or more processors coupled to the memory wherein the one or more processors, when executing the instructions which are stored, are configured to:
access an accelerator, wherein the accelerator includes a weight-stationary systolic array of one or more multiply-accumulate units, wherein the accelerator is coupled to a memory hierarchy, and wherein the memory hierarchy is coupled to a processor core;
send, by the processor core, a work request to the accelerator, wherein the work request is based on execution of a machine learning model and an activation matrix;
load, by the accelerator, a weight matrix and the activation matrix, wherein the loading is responsive to the work request and wherein the loading uses the memory hierarchy;
multiply, by the accelerator, the weight matrix by the activation matrix, wherein the multiplying results in an answer matrix;
store, by the accelerator, the answer matrix in the memory hierarchy; and
obtain, by the processor core, from the memory hierarchy, the answer matrix that was stored.
